(19) United States
(12) Patent Application Publication
(10) Pub. No.: US 2015/0162175 A1
(43) Pub. Date: Jun. 11, 2015

(54) Methods for Isolation and Decomposition of Mass Spectrometric Protein Signatures

(71) Applicant: Thermo Finnigan LLC, San Jose, CA (US)

(72) Inventor: David A. WRIGHT, Livermore, CA (US)

(73) Assignee: Thermo Finnigan LLC, San Jose, CA (US)

(21) Appl. No.: 14/103,527

(22) Filed: Dec. 11, 2013

(51) Int. Cl. H01J 49/00

(52) U.S. Cl. CPC H01J 49/0031; H01J 49/0036

(57) ABSTRACT

A method of analyzing a liquid mixture comprising protein or peptide molecules mixed with other molecules comprises: passing a portion of the mixture through a liquid chromatograph so as to elute the molecules; transferring the eluted portions of the molecules to an ion source of a mass spectrometer so as to generate ions comprising a plurality of ion species therefrom; transferring the generated ion species to a mass analyzer for detection thereby; generating a respective record of the intensity-versus-time variation of each of a plurality of the detected ion species; identifying and distinguishing a set of ion species corresponding to the ions generated from the eluted portion of the protein or peptide analyte molecules based on the records of the intensity-versus-time variation; and performing at least one additional operation on ions of one or more of the distinguished ion species generated from the protein or peptide analyte molecules.

### CROSS-REFERENCE TO RELATED APPLICATIONS

This application is related to co-pending U.S. patent application Ser. No. 13/682,384 (attorney docket no. 8896US1/NAT) titled “Use of Neutral Loss Mass to Reconstruct MS-2 Spectra in All Ions Fragmentation” which was filed on Nov. 20, 2012 and which is assigned to the assignee of the present application. This application is also related to co-pending U.S. patent application Ser. No. 13/682,443 (attorney docket no. 14849US1/NAT) titled “Automatic Reconstruction of MS-2 Spectra from All Ions Fragmentation to Recognize Previously Detected Compounds” which was filed on Nov. 20, 2012 and which is assigned to the assignee of the present application. This application is also related to co-pending U.S. patent application Ser. No. 13/721,603 (attorney docket no. 15926US1/NAT) titled “Methods and Apparatus for Identifying Ion Species Formed during Gas-Phase Reactions” which was filed on Dec. 20, 2012 and which is assigned to the assignee of the present application. This application is also related to co-pending U.S. patent application Ser. No. 13/785,620 (attorney docket no. 15995US1/NAT) titled “Methods and Apparatus for Decomposing Tandem Mass Spectra Generated by All-Ions Fragmentation” which was filed on Mar. 5, 2013 and which is assigned to the assignee of the present application. This application is also related to co-pending U.S. patent application Ser. No. 13/375,676 which was filed on May 25, 2010 and which is published as US pre-grant publication No. 2012/0089342 A1 and which is assigned to the assignee of the present application. This application is further related to co-pending U.S. patent application Ser. No. 12/970,570 which was filed on Dec. 16, 2010 and which is published as US pre-grant publication No. 2012/0158318 A1 and which is assigned to the assignee of the present application. This application is yet further related to co-pending U.S. patent application Ser. No. 13/300,287 which was filed on Nov. 18, 2011 and which is published as US pre-grant publication No. 2013/0131998 A1 and which is assigned to the assignee of the present application.

### FIELD OF THE INVENTION

This invention relates to methods of analyzing data obtained from instrumental analysis techniques used in analytical chemistry and, in particular, to methods of analyzing proteins, peptides and other organic molecules in biologically-derived samples using mass spectrometry.

### BACKGROUND OF THE INVENTION

Proteomics is the study and analysis of proteins in biological samples. One important aspect of proteomics is the identification and recognition of particular proteins (biomarkers) that are associated with various diseases. Thus, the recognition of one or more disease-related biomarkers can aid diagnoses. Mass spectrometry (MS) is an important and useful tool in the identification and quantitation of biomarkers—including disease-related biomarkers—and other proteins in natural samples. In recent years, mass spectrometry has gained additional popularity as a tool for identifying microorganisms due to its increased accuracy and shortened time-to-result when compared to traditional methods for identifying microorganisms. Generally speaking, mass spectrometry is an analytical technique to filter, detect, identify and/or measure compounds by the mass-to-charge ratios of ions formed from the compounds. The quantity of mass-to-charge ratio is commonly denoted by the symbol “m/z” in which “m” is ionic mass in units of Daltons and “z” is ionic charge in units of elementary charge, e. Thus, mass-to-charge ratios are appropriately measured in units of “Da/e”. Mass spectrometry techniques generally include (1) ionization of compounds and optional fragmentation of the resulting ions so as to form fragment ions; and (2) detection and analysis of the mass-to-charge ratios of the ions and/or fragment ions and calculation of corresponding ionic masses. The compound may be ionized and detected by any suitable means. A “mass spectrometer” generally includes an ionizer and an ion detector.

The hybrid technique of liquid chromatography-mass spectrometry (LC/MS) is an extremely useful technique for detection, identification and (or) quantification of components of mixtures or of analytes within mixtures. This technique generally provides data in the form of a mass chromatogram, in which detected ion intensity (a measure of the number of detected ions) as measured by a mass spectrometer is given as a function of time. In the LC/MS technique, various separated chemical constituents elute from a chromatographic column as a function of time. As these constituents are eluted from the column, they are submitted for mass analysis by a mass spectrometer. The mass spectrometer accordingly generates, in real time, detected relative ion abundance data for ions produced from each eluting analyte, in turn. Thus, such data is inherently three-dimensional, comprising the two independent variables of time and mass (more specifically, a mass-related variable, such as mass-to-charge ratio) and a measured dependent variable relating to ion abundance.

One can often enhance the resolution of the MS technique by employing “tandem mass spectrometry” or “MS/MS”, for example via use of a triple quadrupole mass spectrometer. In this technique, a first, or parent, or precursor, ion generated from a molecule of interest can be filtered or isolated in an MS instrument, and these precursor ions subsequently fragmented to yield one or more second, or product, or fragment, ions that are then analyzed in a second MS stage. By careful selection of precursor ions, only ions produced by certain analytes are passed to the fragmentation chamber or other reaction cell, such as a collision cell where collision of ions with atoms of an inert gas produces the fragment ions. Because both the precursor and fragment ions are produced in a reproducible fashion under a given set of ionization/fragmentation conditions, the MS/MS technique can provide an extremely powerful analytical tool. For example, the combination of precursor ion selection and subsequent fragmentation and analysis can be used to eliminate interfering substances, and can be particularly useful in identifying and quantifying proteins derived from complex samples, such as biological samples. Selective reaction monitoring (SRM) is one commonly employed tandem mass spectrometry technique.

To date, the most common mass spectrometry method used for microbial identification is matrix-assisted laser desorption ionization time-of-flight (MALDI-TOF) mass spectrometry. The mass spectrum of a microorganism produced by MALDI-TOF methods reveals a number of peaks from intact peptides, proteins, and protein fragments that constitute the microorganism's “fingerprint”. This method relies on the pattern matching of the peaks profile in the mass spectrum of an unknown microorganism to a reference database comprising a collection of spectra for known microorganisms obtained using substantially the same experimental conditions. The better the match between the spectrum of the isolated microorganism and a spectrum in the reference database, the higher the confidence level in identification of the organism at the genus, species, or in some cases, subspecies level. Several other mass spectrometry methods for detection of microorganisms have been used. Alternatively, a different approach, termed “bottom-up” proteomics, widely practiced for purposes of protein identification. In bottom-up proteomics, sequence information is obtained from peptides generated by enzymatic digests of proteins derived from the microbial sample. To identify peptides of the digest, liquid chromatography is coupled to tandem mass spectrometry (LC-MS/MS). This bottom-up approach can provide identification to the subspecies or strain level as chromatographic separation allows the detection of additional proteins other than just the ribosomal proteins that are characteristic of the MALDI-TOF methods. The additional proteins identifiable in the bottom-up approach include those that are useful for characterization of antibiotic resistance markers and virulence factors.

Because proteins and peptides generally comprise large molecular weights, it is a common practice in the study of proteins and peptides by mass spectrometry to arrange for multiple charges to reside on each molecular entity entering the analyzer stage. Because the measured quantity in mass spectrometry is mass-to-charge ratio, the provision of multiply-charged ions allows entities having large masses to be analyzed by an instrument having a limited mass range. Since a range of charges will be attached to each ion, a multiplet consisting of the charges N, N+1, N=2 . . . N+M will be seen, and it is then the task of the practitioner to “deconvolve” this charge state envelope and arrive at the true mass. While this process is very simple in concept, it can be difficult to choose the correct ions in a related envelope if there are a lot of ions, or the resolution is such that ions overlap.

### SUMMARY

In order to simplify and even automate the process of identifying protein-derived or peptide-derived ions in a complex mass spectrum including non-peptide molecules, methods are herein described which increase the selectivity of protein and peptide analysis using LC/MS techniques by filtering out chemical noise. Methods in accordance with the present teachings may employ extracted ion chromatogram (XIC) lineshape correlation to remove ions which are not likely to be proteins, and can be applied to both isotopically resolved high resolution data and unit resolution centroided data. Using this method, the separation of the ions in a mass-spectral “scan” (or average scan) into groups of related by charge-state and isotope composition is computationally simplified and of higher quality. The automated methods and apparatus described herein do not require any user input or intervention.

Thus, according to a first aspect of the present teachings, there is provided a method of analyzing a liquid mixture comprising protein or peptide analyte molecules that occur mixed with molecules of other compounds in a sample, said method comprising: (a) passing a portion of the mixture through a liquid chromatograph such that a portion of the protein or peptide molecules and a portion of molecules of other compounds elute from the liquid chromatograph; (b) transferring, to an ion source of a mass spectrometer, the eluted portion of the protein or peptide analyte molecules and the eluted portion of the molecules of other compounds so as to generate ions therefrom, the ions comprising a plurality of ion species; (c) transferring the generated ions to a mass analyzer of the mass spectrometer so as to detect the transferred ion species; (d) generating a respective record of the intensity-versus-time variation of each of a plurality of the detected ion species; (e) identifying a set of ion species corresponding to the ions generated from the eluted portion of the protein or peptide analyte molecules and distinguishing said identified ion species from a set of ion species corresponding to the ions generated from the eluted portion of the molecules of the other compounds based on the records of the intensity-versus-time variation; and (f) performing at least one additional operation on ions of one or more of the distinguished ion species generated from the protein or peptide analyte molecules.

In various embodiments, the methods in accordance with the present teachings may employ or be used in conjunction with fast partial chromatographic separation. In various embodiments, the methods in accordance with the present teachings may employ or be used in conjunction with conventional tandem mass spectrometry as described above. Thus, in various embodiments, the at least one additional operation may include isolating one or more of the distinguished ion species generated from the protein or peptide molecules within the mass spectrometer and may further include fragmenting ions of the one or more isolated distinguished ion species. Various embodiments may further comprise creating one or more entries in a database of molecule elution profile parameters and retention times based on the generated records of the intensity-versus-time variation. In various embodiments, the at least one additional operation may comprise the steps of: (f1) passing a second portion of the mixture through the liquid chromatograph such that a second portion of the protein or peptide molecules and a second portion of molecules of other compounds elute from the liquid chromatograph; (f2) transferring, to the ion source of the mass spectrometer, the eluted second portion of the protein or peptide analyte molecules and the eluted second portion of the molecules of other compounds so as to re-generate the ion species; (f3) transferring the re-generated ion species to the mass analyzer so as to detect the re-generated ion species; (f4) isolating one or more of the distinguished ion species generated from the second portion of the protein or peptide molecules; (f5) fragmenting the one or more isolated distinguished ion species to as to generate fragment ion species; and (f6) analyzing the fragment ion species using the mass analyzer.

Various other embodiments may employ or be used in conjunction with tandem mass spectrometry by all-ions fragmentation. All-ions fragmentation is a tandem mass spectrometry technique in which several precursor ions are fragmented at once, without first selecting particular precursor ions to fragment.

In various embodiments, the step (e) of identifying a set of ion species corresponding to the ions generated from the eluted portion of the protein or peptide analyte molecules may include identifying a set of ion species comprising a charge state envelope and may further include identifying the charge states of one or more ion species comprising the charge state envelope.

In various embodiments, the step (d) of generating a respective record of the intensity-versus-time variation of each of a plurality of the detected ion species may comprise constructing a plurality of extracted ion chromatograms, wherein each extracted ion chromatogram comprises a record of detected intensity of a respective detected ion species. The construction of the plurality of extracted ion chromatograms may include the steps of: (d1) automatically fitting each of the plurality of intensity-versus-time variation with one or more calculated synthetic fit peaks; (d2) eliminating synthetic fit peaks that do not satisfy an ion occurrence rule requiring the detected peaks to appear within a pre-determined number of consecutive mass spectral scans; and (d3) eliminating synthetic fit peaks that do not satisfy a rule requiring the detected peaks to comprise a minimum intensity and a minimum area. Subsequently, in the performing of the step (e), cross-correlation scores for each pair of synthetic fit peaks may be calculated, wherein the cross-correlation scores are used to identify and distinguish ion species.

The step (e) may further include identifying at least one of the protein or peptide analyte molecules. In such cases, the identity of the at least one identified protein or peptide analyte molecule may be used to identify a microorganism from which the sample was derived.

### BRIEF DESCRIPTION OF THE DRAWINGS

The above noted and various other aspects of the present invention will become apparent from the following description which is given by way of example only and with reference to the accompanying drawings, not drawn to scale, in which:

FIG. 1 is a schematic diagram of a system for generating and automatically analyzing chromatography/mass spectrometry spectra in accordance with the present teachings;

FIG. 2 is a perspective view of a three-dimensional graph of chromatography-mass spectrometry data, in which the variables are time, mass (or mass-to-charge ratio, m/z) and ion abundance;

FIG. 3A is a perspective view of a three-dimensional graph of chromatography-mass spectrometry data showing four hypothetical mass spectra of precursor ions and corresponding mass spectra of fragment ions and showing hypothetical extracted ion chromatograms (XICs) for several different values of mass-to-charge ratio;

FIG. 3B is a perspective view of a portion of the three-dimensional graph of FIG. 15A showing selected peaks as extracted ion chromatograms;

FIG. 4 is a flow chart of a general method for handling mass spectral data in accordance with the present teachings;

FIGS. 5A-5B provide a flowchart of a first method for generating automated correlations between all-ions precursor ions and all-ions-fragmentation product ions in accordance with the present teachings;

FIG. 6A is a flowchart of a method for automated spectral peak detection and quantification in accordance with an embodiment of the present teachings;

FIG. 6B is a schematic example of decomposing a complexly shaped chromatogram trace into resolved peaks;

FIG. 7A is a mass spectrum of a peptide co-eluting with other compounds in a fast partial chromatographic separation;

FIG. 7B is a filtered version of the mass spectrum of FIG. 7A, in which the filtering is performed in accordance with the present teachings so as to illustrate correlated peaks attributable to the peptide;

FIG. 7C is an extracted ion chromatogram (XIC) of an ion attributable to the eluting peptide corresponding to the mass spectrum of FIG. 7A and a fitted peak to the XIC;

FIG. 8A is a second mass spectrum of a peptide co-eluting with other compounds in a fast partial chromatographic separation;

FIG. 8B is a filtered version of the mass spectrum of FIG. 8A, in which the filtering is performed in accordance with the present teachings so as to illustrate correlated peaks attributable to the peptide;

FIG. 8C is an extracted ion chromatogram (XIC) of an ion attributable to the eluting peptide corresponding to the mass spectrum of FIG. 8A and a fitted peak to the XIC;

FIG. 9A is a mass spectrum of a eluting compounds that do not include a protein or peptide;

FIG. 9B is a filtered version of the mass spectrum of FIG. 8A that is filtered to show the most highly correlated peaks;

FIG. 9C is an extracted ion chromatogram (XIC) of an ion attributable to one of the correlated peaks shown in FIG. 9B and a fitted peak to the XIC;

FIG. 10A is a mass spectrum of a group of peptides co-eluting with other compounds in a fast partial chromatographic separation;

FIG. 10B is a filtered version of the mass spectrum of FIG. 10A, in which the filtering is performed in accordance with the present teachings so as to illustrate correlated peaks attributable to the peptides;

FIG. 10C is an extracted ion chromatogram (XIC) of an ion attributable to one of the co-eluting peptides corresponding to the mass spectrum of FIG. 10A and a fitted peak to the XIC; and

FIG. 11 is a scatter plot of peak widths versus retention times of various proteins and peptides in comparison to other compounds.

### DETAILED DESCRIPTION

Filtering by extracted ion chromatogram (XIC) lineshape correlation is a powerful technique that that has been previously applied to decomposing multiplexed MS-2 spectra from “all ions fragmentation” scans and locating isotope or adduct ions. All-ions fragmentation is a tandem mass spectrometry technique in which several precursor ions are fragmented at once, without first selecting particular precursor ions to fragment. The methods of decomposing spectra according to XIC lineshape correlation are taught in co-pending U.S. patent application Ser. No. 12/970,570 filed on Jan. 4 2011 and titled “Method and Apparatus for Correlating Precursor and Product Ions in All-Ions Fragmentation Experiments”, said application published as US Publ. No. 2012/0158318 A1. The application of XIC lineshape filtering to identifying isotope patterns is taught in co-pending U.S. patent application Ser. No. 13/300,287 filed on Nov. 18, 2011 and titled “Methods and Apparatus for Identifying Mass Spectral Isotope Patterns”, said application published as US Publ. No 2013/0131998 A1. The application of XIC lineshape filtering to identifying ion adducts is taught in co-pending U.S. patent application Ser. No. 13/721,603 filed on Dec. 20, 2012 and titled “Methods and Apparatus for Identifying Ion Species Formed during Gas-Phase Reactions”. All of the above-referenced co-pending applications are assigned to the assignee of the present application and incorporated herein by reference in their entireties. In each of these uses of lineshape correlation, only relevant ions are displayed (or otherwise reported or presented for consideration) by limiting the set of output ions to those that are highly correlated. The resulting filtered spectra are thus beneficially simplified relative to original unfiltered spectra.

The chemistry and physics that determine the chromatographic peak shape of a detected ion are unique for the particular molecule from which the ion was formed and cease when the molecule exits the column. Thus, one can expect that XICs having similar shapes may be related. Correlations derived from XIC lineshape rely on the fact that different molecules interact differently with a given chromatographic column, due to the wide range of physiochemical affinities and molecular shapes. However, proteins and peptides do not exhibit this wide range of interactions among themselves, and furthermore one often simply “de-salts” a protein-containing or peptide-containing sample in a short chromatographic run, which provides very minimal separation and peak shape differentiation. Fortunately, as the inventor has discovered, lineshape correlation can still provide a filtering effect. So, if one filters by lineshape, non-protein/peptide ions may be eliminated, simplifying the task of finding charge-state chains.

The present disclosure makes use of the terms “ion” (or “ions” in the plural) and “ion species”. For purposes of this disclosure, an “ion” is considered to be a single, solitary charged particle, without implied restriction based on chemical composition, mass, charge state, mass-to-charge (m/z) ratio, etc. A plurality of such charged particles comprises a collection of “ions”. An “ion species”, as used herein, refers to a category of ions—specifically, those ions having a given monoisotopic m/z ratio—and, most generally, includes a plurality of charged particles, all having the same monoisotopic m/z ratio. This usage includes, in the same ion species, those ions for which the only difference or differences are one or more isotopic substitutions. One of ordinary skill in the mass spectrometry arts will readily know how to recognize isotopic distribution patterns and how to relate or convert such distribution patterns to monoisotopic masses. The term “scan” as used herein is used loosely to refer to any mass spectrum—such as a precursor-ion mass spectrum, a product-ion mass spectrum, both a precursor-ion mass spectrum and an associated product-ion mass spectrum considered together, etc. This terminology usage is employed even though many instances of mass spectrometer instruments that may produce data suitable for analysis according to the present teachings are not, strictly speaking, mass-scanning-type instruments.

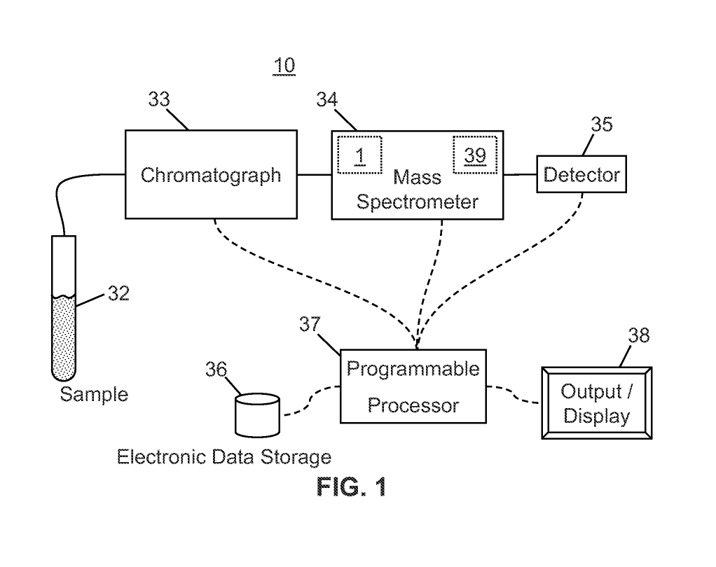

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. The particular features and advantages of the invention will become more apparent with reference to the appended FIGS. 1-11, taken in conjunction with the following description.

### Section 1. General Considerations

FIG. 1 is a schematic diagram of a system 10 for generating and automatically analyzing chromatography/mass spectrometry spectra in accordance with the present teachings. A chromatograph 33, such as a liquid chromatograph, high-performance liquid chromatograph or ultra high performance liquid chromatograph receives a sample 32 of an analyte mixture and at least partially separates the analyte mixture into individual chemical components, in accordance with well-known chromatographic principles. As a result, the at least partially separated chemical components are transferred to a mass spectrometer 34 at different respective times for mass analysis. As each chemical component is received by the mass spectrometer, it is ionized by an ionization source 1 of the mass spectrometer. The ionization source 1 may produce a plurality of ions (i.e., a plurality of precursor ions) comprising differing charges or masses from each chemical component. Thus, a plurality of ions of differing mass-to-charge ratios may be produced for each chemical component, each such component eluting from the chromatograph at its own characteristic time or within its own characteristic time range. These various ions are analyzed and detected by the mass spectrometer together 34 with its detector 35 and, as a result, appropriately identified according to their various mass-to-charge ratios. The mass spectrometer may comprise one or more reaction cells 39 (such as, for example, a collision cell or an ion-ion reaction cell) to fragment or cause other reactions of the precursor ions, thereby producing fragment or other product ions.

Still referring to FIG. 1, a programmable processor 37 is electronically coupled to the detector of the mass spectrometer and receives the data produced by the detector during chromatographic/mass spectrometric analysis of the sample(s). The programmable processor may comprise a separate stand-alone computer or may simply comprise a circuit board or any other programmable logic device operated by either firmware or software. Optionally, the programmable processor may also be electronically coupled to the chromatograph and/or the mass spectrometer in order to transmit electronic control signals to one or the other or both of these instruments so as to control their operation. The nature of such control signals may possibly be determined in response to the data transmitted from the detector to the programmable processor or to the analysis of that data. The programmable processor may also be electronically coupled to a display or other output 38, for direct output of data or data analysis results to a user, or to electronic data storage 36. The programmable processor shown in FIG. 1 is generally operable to receive a mass spectrum, such as a precursor-ion mass spectrum or a product-ion mass spectrum (or both) from the chromatography/mass spectrometry apparatus and to automatically perform the various data analysis, data retrieval and data storage operations in accordance with the various methods discussed below.

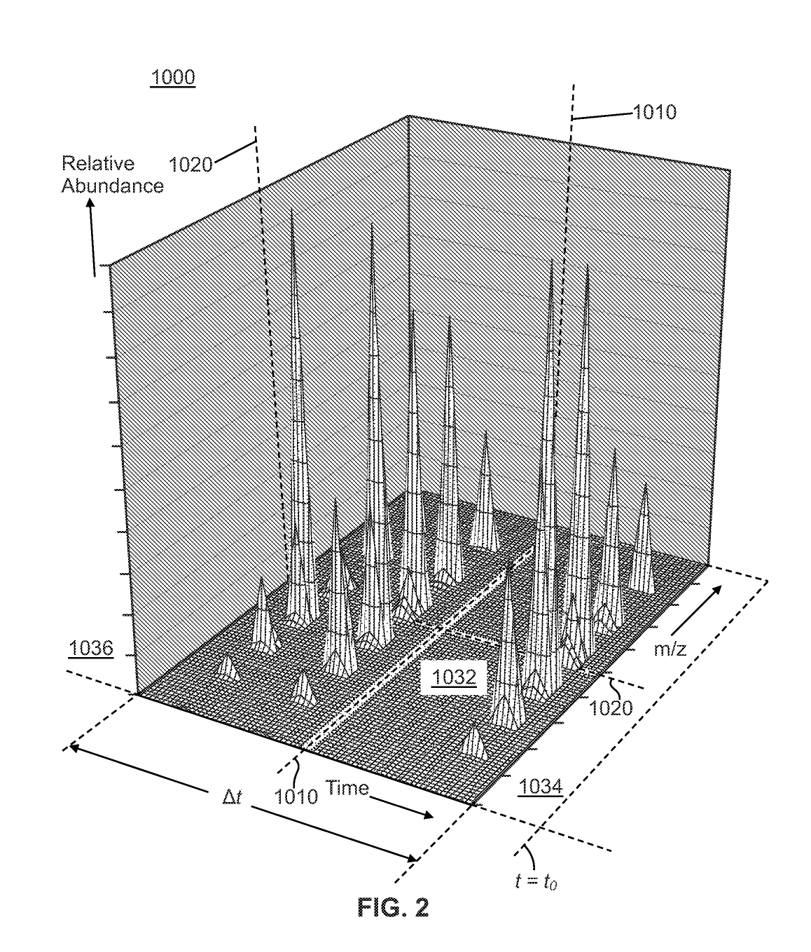

FIG. 2 is a perspective view of a three-dimensional graph of hypothetical LC/MS data. As is common in the representation of such data, the variables time and mass (or mass-to-charge ratio, m/z) are depicted on the “floor” of the perspective diagram and the variable representing ion abundance (for instance, detected ion current) is plotted in the “vertical” dimension of the graph. Thus, ion abundance is represented as a function of the other two variables, this function comprising a variably shaped surface above the “floor”. Each set of peaks dispersed and in line parallel to the m/z axis represents the various ions produced by the ionization of a single eluting analyte (or, possibly, of fortuitously co-eluting analytes or analytes co-eluting with other compounds) at a restricted range of time. In a well-designed chromatographic experiment, each analyte of a mixture will elute from the column (thereby to be mass analyzed) within a particular diagnostic time range. Consequently, either a single peak or a line of mass-separated peaks, each such peak representing a particular ion produced by the eluting analyte, analytes or other compounds, is expected at each elution time (or retention time) range.

For clarity, only a very small number of peaks are illustrated in FIG. 2. In practice, data obtained by a chromatography-mass spectrometry experiment may comprise a very large volume of data. A mass spectrometer may generate a complete “scan” over an entire mass range of interest in a matter of tens to hundreds of milliseconds. As a result, up to several hundred complete mass spectra may be generated every second. Further, the various analytes may elute over a time range of several minutes to several tens of minutes, depending on the complexity of the mixture under analysis and the range of retention times represented.

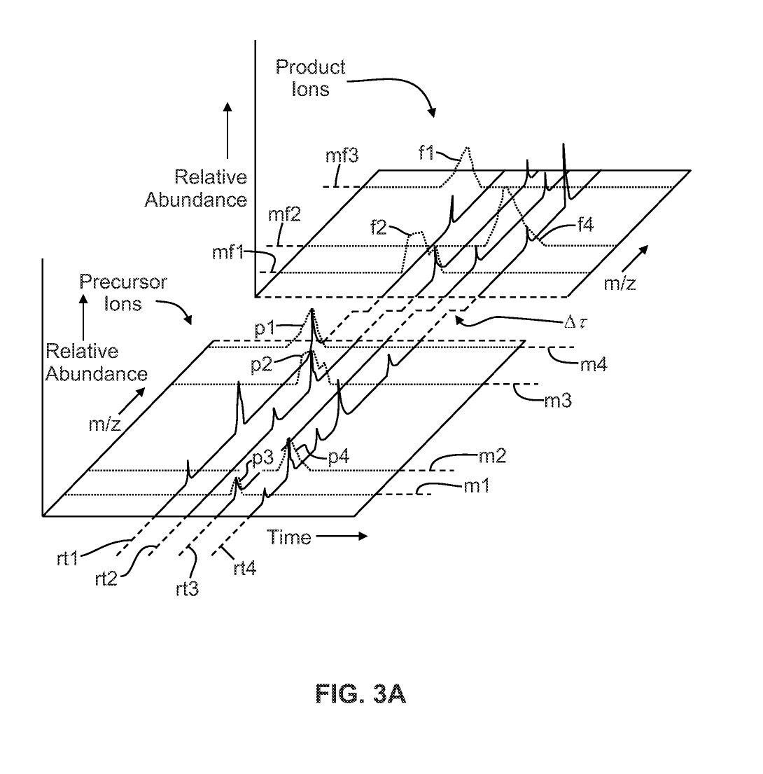

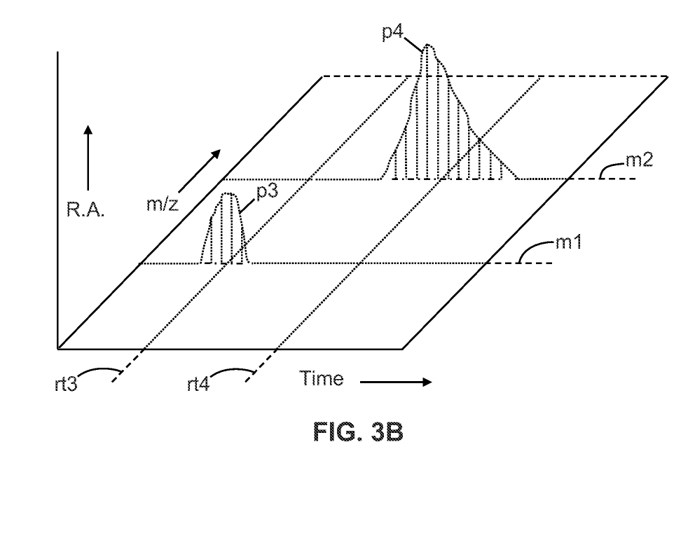

When the chromatography-mass spectrometry experiment and data generation are performed by a mass spectrometer system that performs both all-ion precursor ion scanning and all-ions product ion scanning, the data for each eluate will logically comprise two data subsets which are interleaved with one another in time, each of which is similar to the data set illustrated in FIG. 2. One of these data subsets will contain the data for the precursor ions and the other data subset will contain the data for the product ions. Such a situation is illustrated schematically in FIGS. 3A-3B, discussed in greater detail in following paragraphs. The data set containing the product ion peaks may also contain some peaks corresponding to residual un-fragmented or un-reacted precursor ions.

Returning to the discussion of FIG. 2, the data depicted therein may comprise an entire stored data file representing results of a prior experiment. Alternatively, the depicted data may represent a portion of a larger data set in the process of being acquired by an LC/MS instrument. For instance, the data depicted in FIG. 2 may comprise recently collected data held in temporary computer readable memory, such as a memory buffer, and corresponding to an analysis time window, Δt, upon which calculations are being formed while, at the same time, newer data is being collected. Such newer, not-yet-analyzed data is represented, in time and m/z space, by region 1034 and the data actually being collected is represented by the line t=t₀. Older data which has already been analyzed by methods of the present teachings and which has possibly been stored to a permanent computer readable medium, is represented by region 1036. With such manner of operation, methods in accordance with the present teachings are carried out in near-real-time on an apparatus used to collect the data or using a processor (such as a computer processor) closely linked to the apparatus used to collect the data.

Operationally, data such as that illustrated in FIG. 2 is collected as separate mass spectra (also referred to herein as “scans”), each mass spectrum (scan) corresponding to a particular respective time point. Such mass spectra may be envisioned as residing within planes parallel to the plane indicated by the trace lines 1010 in FIG. 2 or parallel to the lines rt1, rt2, rt3 and rt4 in FIG. 3A. If an experiment employs all-ions fragmentation, then, as illustrated in FIG. 3A, each precursor-ion scan may correspond to a respective product-ion scan. Once at least a portion of data has been collected, such as the data in region 1032 in FIG. 2, then the information in the data portion may be logically re-organized as extracted ion chromatograms (or, at least portions thereof). Each such XIC may be envisioned as a cross section through the data in a plane parallel to the plane indicated by trace lines 1020 in FIG. 2 or parallel to the lines m1, m2, m3, m4, mf1, mf2, and mf3 in FIG. 3A. Hypothetical extracted ion chromatograms are shown as dotted lines in FIG. 3A and FIG. 3B. Each XIC represents the elution profile, in time, of ions of a particular mass-to-charge range. The XIC representation of the data is useful for understanding the methods of the present teachings.

Several schematic hypothetical XIC profiles are shown in FIGS. 3A-3B. These profiles include several example peaks. The illustrated precursor scan peaks are peak p1 at coordinates (rt1, m4), peak p2 at coordinates (rt2, m3), peak p3 at coordinates (rt3, m1) and peak p4 at coordinates (rt4, m2). Three product ion scan peaks are also illustrated: peak f1 at coordinates (rt1, mf3), peak f2 at coordinates (rt2, mf1) and peak f4 at coordinates (rt4, mf2). Under some experimental conditions which include all-ions fragmentation, the precursor-ion and product-ion scans alternate in time. Thus, even though the time lines rt1, rt2, rt3 and rt4 correspond to the maximum production of precursor ions of different nearly-co-eluting compounds, the respective immediately-following product ion scans are offset in time, relative to the maxima, by a time delay increment Δτ. Even though precursor ion and product ion scans may not be coincident in time, there are generally a sufficient number of precursor ion scans and product ion scans to permit discernment of the profiles of the peaks.

### Section 2. General Procedure

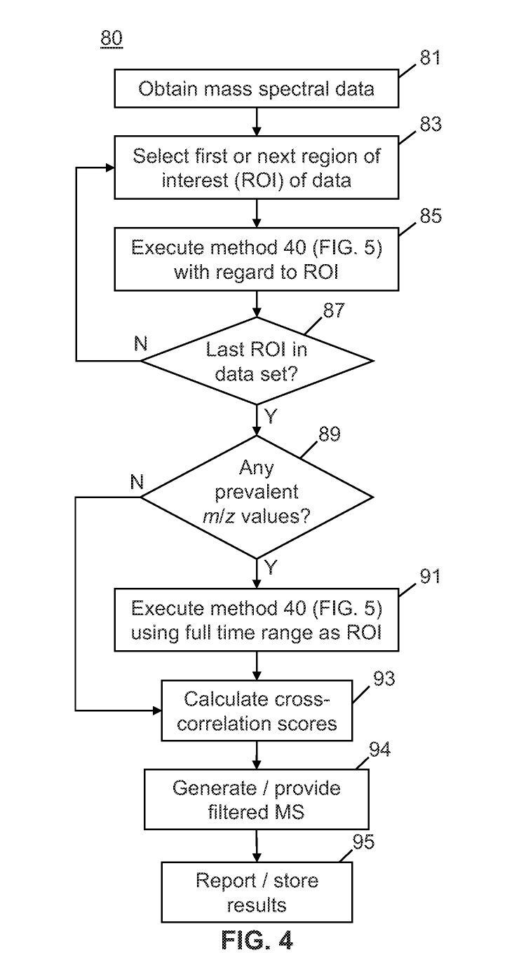

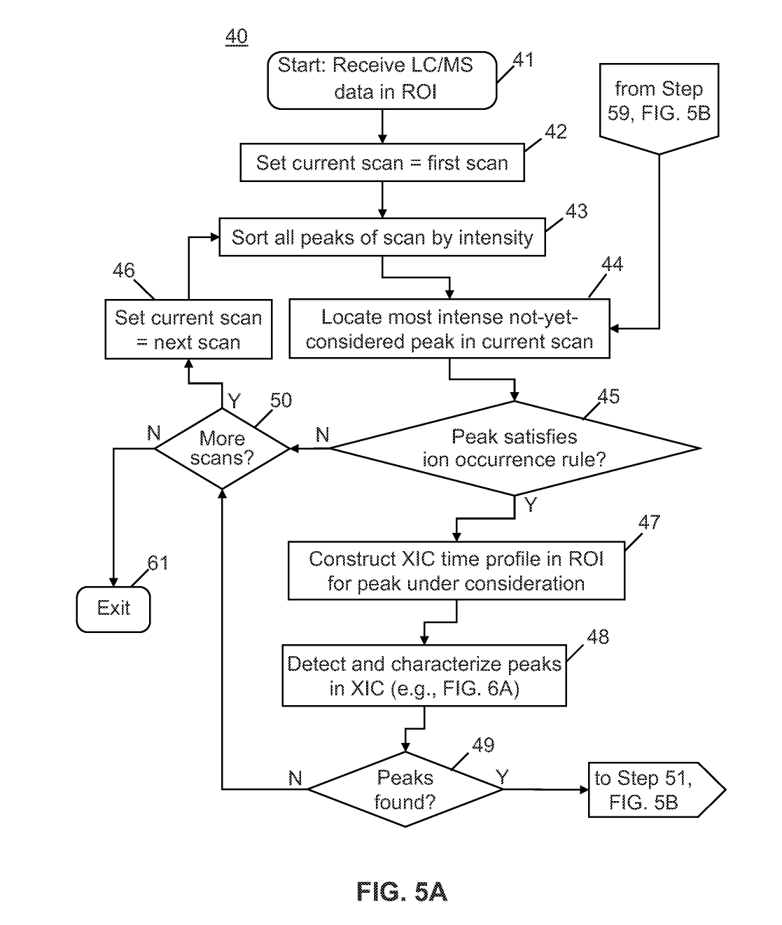

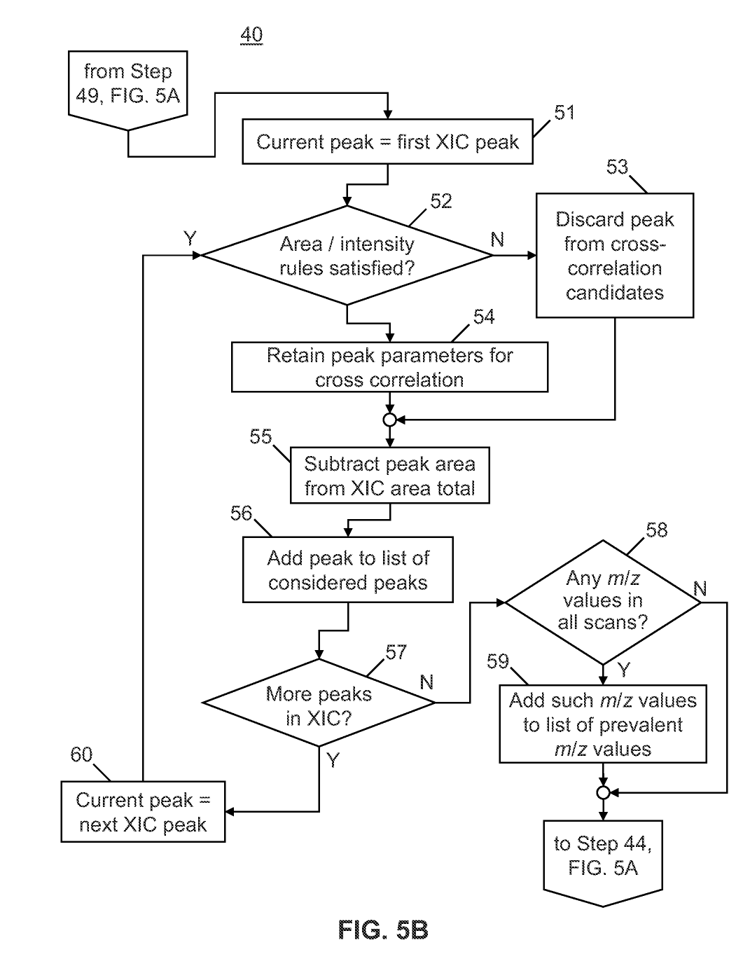

FIG. 4 is a flow chart of a first general method 80 for handling and analyzing mass spectral data in accordance with the present teachings. In Step 81, of the method 80, mass spectral data is obtained, either by acquiring new data directly from a mass spectrometer during the course of an experiment or, alternatively, by inputting previously-generated or previously-observed data from a data file or from a data storage device. In Step 83, a first region of interest (ROI) is selected, the region of interest including data within a particular time slice or time window. For example, the region 1032 illustrated in FIG. 2 may comprise such a region of interest. In Step 85, the data within the currently selected ROI is analyzed in accordance with the method 40 illustrated in FIG. 5 and discussed below in reference to that figure. In brief, the method 40 is a method for automatically recognizing correlations between elution profiles within the selected region of interest. After the determination of any and all such correlations within the currently selected ROI in Step 85, if there are additional regions of interest to be considered (Step 87), execution returns to Step 83 and the next ROI is selected in considered in turn.

After all regions of interest have been considered, then execution of the method 80 proceeds to Step 89 in which the existence of any potential “prevalent m/z values” is noted. As used herein, the term “prevalent m/z value” refers to any m/z value that is associated with a mass chromatogram peak that either is too broad in time to be fully encompassed by any of the regions of interest analyzed in Step 85. Since the edges of such a peak will not both be observed in any one region of interest, correct characterization of such a peak is not possible when employing the peak detection routines of the method 40 (discussed further below) in conjunction with data in a single ROI. Although such peaks cannot be properly characterized in any one ROI, their existence may nonetheless be noted (and recorded) by the prevalence of above-baseline signal in association with one or more particular m/z values within all mass scans within a region of interest (see Steps 58 and 59 of the method 40 discussed in greater detail below). Accordingly, in Step 91 of the method 80, the method 40 (FIG. 5) is executed once again whereby, in this case, the entire time range of the mass spectral data is considered to comprise a new region of interest. Execution of the method 40 in Step 91 in this fashion permits proper characterization of those mass chromatogram peaks which do not fully reside within any one region of interest selected in Step 83.

After execution of the Steps 81-91 of the method 80 (FIG. 4), parameters of synthetic fit peaks to certain of the chromatogram peaks within the data set will be available for further analysis. Specifically, these fit parameters will be available for those chromatogram peaks which satisfy certain criteria, as discussed in greater detail in the discussion below relating to the method 40. The parameters of synthetic fit peaks are stored in Step 54 of the method 40 (see FIG. 5B) as suitable peaks in extracted ion chromatograms are identified. These parameters are then used to calculate cross-correlation scores in Step 93 of the method 80 (see FIG. 4) and these correlation scores are used to identify correlated ions. In brief, the cross correlation for each retained peak is calculated with respect to every other mass that formed an XIC peak. The details of the calculations are presented in a subsequent section herein. In Step 94, the calculated cross-correlation scores are used so as to generate and/or provide a filtered mass spectrum. The filtered mass spectrum may be generated, for example, by eliminating all peaks for which all of the cross correlation scores are below a certain threshold. The peaks that remain after filtering will then all have pairwise cross-correlation score values, among themselves, that are greater than the threshold.

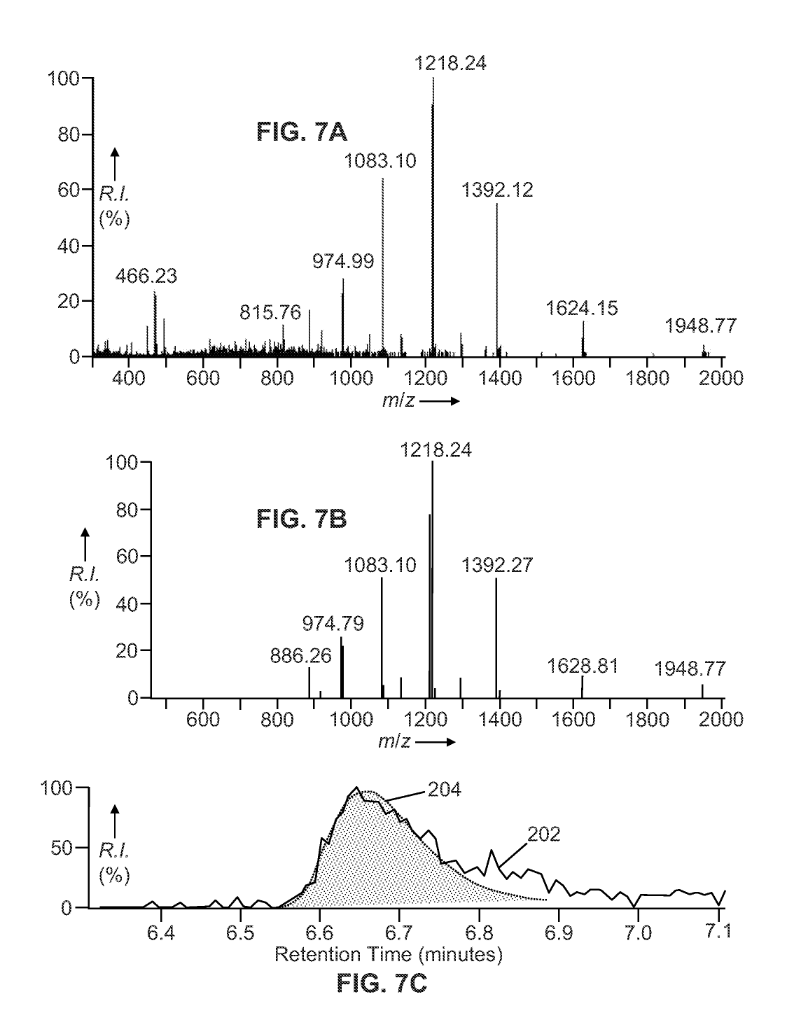

Finally, the results of the calculations or identifications are then reported or stored in Step 95. The results may include a list of peaks having pairwise cross-correlation scores above a certain threshold values. The reporting may be performed in numerous alternative ways—for instance via a visual display terminal, a paper printout, or, indirectly, by outputting the parameter information to a database on a storage medium for later retrieval by a user. The reporting step may include reporting either textual or graphical information, such as the filtered mass spectra shown in FIGS. 7B, 8B, 9B and 10B, or both. Reported peak parameters may be either those parameters calculated during the peak detection step or quantities calculated from those parameters and may include, for each of one or more peaks, location of peak centroid, location of point of maximum intensity, peak half-width, peak skew, peak maximum intensity, area under the peak, etc. Other parameters related to signal to noise ratio, statistical confidence in the results, goodness of fit, etc. may also be reported in Step 95. The information reported in Step 95 may also include characterizing information on one or more analytes and may be derived by comparing the results obtained by the methods described herein to known databases. Such information may include chemical identification of one or more analytes (e.g., ions, molecules or chemical compounds), purity of analytes, identification of contaminating compounds, ions or molecules or, even, a simple notification that an analyte is (or is not) present in a sample at detectable levels.

### Section 3. Extracted Ion Chromatogram Generation

As briefly noted in the previous paragraphs, FIGS. 5A-5B present a flowchart of a first method 40 for generating automated correlations between XIC peaks in accordance with the present teachings. In the initial step, Step 41 (FIG. 5A), LC/MS data generated by a chromatograph-mass spectrometer apparatus is received (for example, from either Step 85 or Step 91 of the method 80 shown in FIG. 4). In procedures employing all-ions fragmentation, the LC/MS data may comprises two data subsets, as shown in FIG. 3A—one data subset containing data for precursor ions and the other data subset containing data for all the fragment ions formed by reaction or fragmentation of all the precursor ions. The data set (or each data subset) comprises ion abundance (or relative abundance) information as a function of time and m/z.

The calculations of method 40 are performed on a chosen time window of the data set. This time-window may correspond to a current region of interest (ROI) of recently collected data, such as region 1032 of FIG. 2. In embodiments, this window is 0.6 minutes wide. This time windows represent a small portion of a typical chromatographic experiment which may run for several tens of minutes to on the order of an hour. In some implementations, data dependent instrument control functions may be performed in automated fashion, wherein the results obtained by the methods herein are used to automatically control operation of the instrument at a subsequent time during the same experiment from which the data were collected. For instance, based on the results of the algorithms, one or more particular identified protein or peptide ion (or ions) may be automatically selected for further fragmentation and analysis in a fragmentation cell or a reaction cell of a mass spectrometer.

The data of the region of interest may be systematically examined in the time window, by searching for peaks to be tested by subsequent cross-correlation calculation. For example, an algorithm in accordance with the present teachings may progress through the data, scan-by-scan. In the present example, the window width is only 0.3 minutes wide at time zero since there is no data before time=0. As scans of higher time are examined, the window increases until the scan at time 0.3 minutes uses a window of the specified 0.6 minutes. In practice the time window width may vary widely.

In Step 42 of the exemplary method 40 (FIG. 5A), the scan to be examined (the current scan) is set to be the initial scan within the ROI. This is an initialization step for a loop in which scans are sequentially examined. In Step 43, the peaks of the current scan are sorted by intensity and the ions are examined one by one, starting with the most intense (Step 44). In general, all ions are examined, but for very rapid work or strong signals, a threshold may be applied and only ions with intensities above threshold examined. In the present example, Step 61 is performed when all ions in all scans of the ROI have been examined. In Step 45, the occurrence of an ion is noted, and its history or time-profile is compared to a rule for ions to be considered as forming a peak. A preferred rule that is used is that the ion must occur in three contiguous scans (scans of the same type), but any rule based on ion appearance and scan number may be used. For example, a rule that the ion must appear in 3 of 5 contiguous scans might alternatively be chosen. (Ions are considered identical if they agree within the mass tolerance, and as an ion history is accumulated, any new occurrence is compared to the average value of the previous instances, not simply the previous instance.)

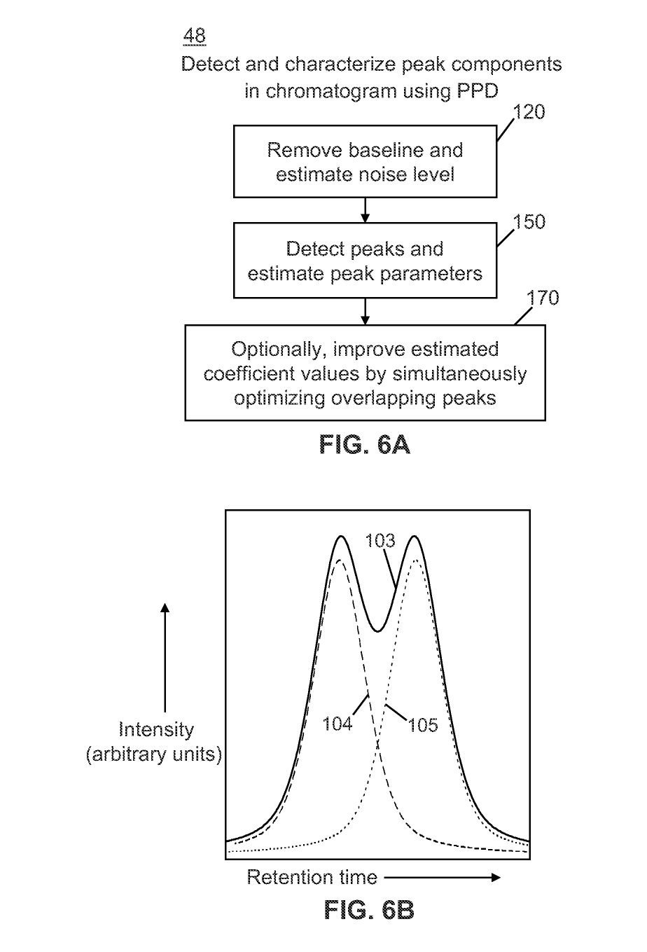

If, in Step 45, the peak does not satisfy the ion occurrence rule, then, if there are more unexamined scans in the ROI (determined in Step 50), the current scan is set to be the next unexamined scan (Step 46) and the method returns to Step 43 to begin examining the new current scan. If the ion occurrence rule (as determined in Step 45) is satisfied, then an extracted ion chromatogram (XIC) corresponding to the mass range of the ion peak under consideration is constructed in Step 47. It is to be noted that the terms “mass” and “mass-to-charge” ratio, as used here, actually represent a small finite range of mass-to-charge ratios. The width or “window” of the mass-to-charge range is the stated precision of the mass spectrometer instrument. The technique of Parameterless Peak Detection (PPD, see FIG. 6A and additional discussion in U.S. Pat. No. 7,983,852 assigned to the assignee of the instant invention and incorporated herein in its entirety) may then be employed to find peaks in an extracted ion chromatogram (XIC) corresponding to this time window in Step 48. Once this particular mass has been tested for peaks in the XIC, it is not tested again until the center of the time window has increased by the window size. (So, for example, using this strategy, if an ion is tested for peaks when the time window is 2-2.6, it will not be tested again until the window is 2.6-3.2.) Alternatively, to avoid the potential problem of a peak that maximizes just at the window boundary, the position of the window center can be incremented by an amount that is somewhat less than the window width. The detecting and characterizing step (Step 48) may employ, without limitation, Parameterless Peak Detection as described in U.S. Pat. No. 7,983,852 in order to decompose a chromatogram trace comprising overlapping or partially overlapping peaks within the XIC under consideration. This decomposition enables separating of the effects of co-eluting compounds.

If, in the decision step, Step 49, no component peaks are found by PPD for the mass under consideration, then, if there are remaining unexamined scans (Step 50), the method returns back to Step 46 and then Step 43. However, if peaks are found, then the method continues to Step 51 (FIG. 5B) in which the first of possibly several peaks in the XIC is set for initial consideration. In the next step, Step 52, for each peak found by PPD, additional rules of large relative area and high relative intensity (described in further detail in the next paragraph) are applied. Peaks that fail these tests are discarded (Step 53), whereas those that pass are accepted and have their descriptive parameters retained (Step 54) for further processing by cross-correlation score calculations (such as in Step 93 of method 80 shown in FIG. 4). Regardless of whether or not a peak is accepted, after each peak is considered, the peak area of the peak is subtracted (Step 55) from the total area used in the relative area criterion in subsequent iterations of Step 52. Also (Step 56) the peak is added to a list of peaks within the ROI that have been examined, to prevent possible duplicate consideration of a single peak.

The Step 52 of the method 40 is now discussed in more detail. In Step 52, the area of, Aⱼ, of the peak currently under consideration (the j^{th} peak) is noted. Also, the total area (IA) under the curve the fitted extracted-ion chromatogram and the average peak signal intensity (Iₐᵥₑ) at the locations of any remaining peaks in the fitted chromatogram are calculated. The area IA is the area of the data remaining after any previously considered peaks have been detected and removed. The Step 52 compares the area, Aⱼ, of the most recently found peak to the total area (IA). Also, this step compares the peak maximum intensity, Iⱼ, of the most recently found peak is compared to Iₐᵥₑ. If it is found either that (Aⱼ/ΣA)<ω or that (Iⱼ/Iₐᵥₑ)<ρ, where ω and ρ are pre-determined constants, then the execution of the method 40 branches to Step 53 in which the peak is removed from a list of peaks to be considered in—and is thus eliminated from consideration in—the subsequent cross-correlation score calculation step. The removal of certain peaks in this fashion renders the fitted peak set consistent with the expectations that, within an XIC, each actual peak of interest should comprise a significant peak area, relative to the total peak area and should comprise a vertex intensity that is significantly greater than the local average intensity.

Returning to the discussion of the method 40 (FIG. 5B), it may be noted that if more peak components exist in the XIC under consideration (decision Step 57), then the method branches to Step 60 in which the next XIC peak component is set for consideration and then back to Step 52. If, however, no additional peaks remain in the XIC, then execution proceeds to Step 58, in which a determination is made regarding whether or not any m/z values are associated with significant signal intensity above baseline in many or all scans (i.e., mass spectra) of the current XIC within the current ROI. As discussed in a previous section, such m/z values will likely correspond to “prevalent m/z values” that are associated with chromatogram peaks spanning a range of time greater than the range of time of the current ROI. Any such possible prevalent m/z values are noted in Step 59. After execution of either Step 58 or Step 59, execution returns to Step 44 (FIG. 5A) so as to continue examining additional peaks (if any) in the current ROI. The above-described sequence continues until all peaks in the current ROI have been examined and, consequently, all precursor ion peaks or product ion peaks to be used for matching have been identified. In this exemplary method, if no further scans exist within the region of interest (Step 50), then the method terminates at Step 61.

The method 40 diagrammed in FIGS. 5A-5B provides a high-level overview of generating extracted ion chromatogram representations of mass spectral data. At a lower level, the Step 48 includes detecting and locating peaks in various extracted-ion-chromatogram (XIC) representations of the data and may itself be regarded as a particular method, which is shown in flowchart form in FIG. 6A. Since each XIC includes only the single independent variable of time (e.g., Retention Time), this section is thus directed to detection of peaks in data that includes only one independent variable. The various sub-procedures or sub-methods in the method 48 may be grouped into three basic stages of data processing as illustrated in FIG. 6A, each stage possibly comprising several steps. The first stage, Step 120, of the method 48 is a preprocessing stage in which baseline features may be removed from the received chromatogram and in which a level of random “noise” of the chromatogram may be estimated. The next stage, Step 150, is the generation of an initial estimate of the parameters of synthetic peaks, each of which models a positive spectral feature of the baseline corrected chromatogram. Such parameters may relate, for instance, to peak center, width, skew and area of modeled peaks, either in preliminary or intermediate form. The subsequent optional stage, Step 170, includes refinement of fit parameters of synthetic peaks determined in the preceding Step 150 in order to improve the fit of the peaks, taken as a set, to the baseline corrected chromatogram. The need for such refinement may depend on the degree of complexity or accuracy employed in the execution of modeling in Step 150. The optional refinement step comprises exploring the space of all parameters across all peaks to find the set of values that minimizes the sum of squared differences between the observed and model chromatogram. This contrasts somewhat with the procedure employed in Step 150, in which peaks are detected and modeled individually or in pairs. Preferably, the squared difference may be calculated with respect to the portion of the chromatogram comprising multiple or overlapped peaks. It may also be calculated with respect to the entire chromatogram. The model chromatogram is calculated by summing the contribution of all peaks estimated in the previous stage.

The purpose of the method 48, as outlined in FIG. 6A, is to decompose a chromatogram trace into component peaks, such as the peaks 104 and 105 schematically illustrated in FIG. 6B. The Step 48 is outlined in brief in FIG. 6A. The individual steps shown in FIG. 6A are discussed in much greater detail in the aforementioned U.S. Pat. No. 7,983,852.

Several schematic extracted ion chromatograms are illustrated in FIG. 3A by dotted lines residing at respective mass-to-charge values indicated by sections m1, m2, m3 and m4 as well as at mass-to-charge values indicated by sections mf1, mf2 and mf3. Subsequent to execution of the methods discussed above, each such XIC is defined by the set of synthetic peaks calculated by those methods. The hypothetical synthetic extracted ion chromatograms schematically shown in FIG. 3A illustrate elution of various ionized chemical constituents at closely-spaced times rt1, rt2, rt3 and rt4. Although illustrated as separated times, one or more of the times rt1, rt2, rt3 and rt4 could even be identical to one another, such that the various chemical constituents are co-eluting constituents. It should be noted that the mass scale (i.e., m/z scale) relating to product ion scans (if any) in FIG. 3A is not a simple extension of the mass scale relating respectively relating to precursor ion scans. In fact, the two mass scales may overlap one another but are not necessarily identical to one another.

Comparison of the illustrated XIC peak profiles in FIG. 3A illustrates how profiles relating to elution of different compounds may be expected to have different respective shapes. Since the chemistry and physics that determine the chromatographic peak shape are unique for each molecule and cease when the molecule exits the column, one can expect that XICs having similar shapes may be related. A stronger statement can be made that XICs that have different shapes are not fragments of the same precursor. By using Parameterless Peak Detection (PPD) or other automated peak detection and fitting techniques, as described above, to characterize the peak shape, small differences in shape can be encoded in a correlation vector (described in more detail following). This can be enhanced by additional smoothing after the peak is detected (but not before, since prior smoothing can smooth a noise spike into a peak). Step 93 of method 80 (FIG. 4) is the cross-correlation step which is described in more detail in the following paragraphs.

### Section 4. Cross-Correlation Score Calculations

Overall cross-correlation scores (CCS) in accordance with the present teachings are calculated (i.e., in Step 93 of method 80) according to the following strategy. For each mass in the experimental data that is found to form a chromatographic peak by PPD as described in Section 2, the cross correlation score taken with regard to every other respective peak-forming mass is computed. In the present context, the term “peak” refers simply to masses that have non-zero intensity values for several contiguous or nearly contiguous scans (for example, the scans at times rt1, rt2, rt3 and rt4 illustrated in FIG. 3A) of the same filter type. Each cross-correlation score may include a peak shape correlation score (calculated in terms of a time-versus-intensity for each mass that forms a recognized peak).

The calculation of peak-shape cross correlations may use a trailing retention time window. The calculation makes use of a numerical array including mass, intensity, and scan number values for every mass that forms a chromatographic peak. As described previously in this document, Parameterless Peak Detection (PPD) is used to calculate a peak shape for each mass component. This shape may be a simple Gaussian or Gamma function peak, or it may be a sum of many Gaussian or Gamma function shapes, the details of which are stored in a peak parameter list. Once the component peak shape has been characterized by an analytical function (which may be a sum of simple functions), the problem of calculating a dot-product correlation is greatly simplified. It is thus trivial to calculate a cross correlation, here considered as a simple vector product (“dot product”). These cross correlations are normalized by also calculating, and dividing by, the autocorrelation values. Consequently, the peak shape correlation (PSC) between two XIC peak profiles, p1 and p2 (denoted, functionally as p1(t) and p2(t), where t represents a time variable, may be calculated as

$$PSC ( p 1 , p 2 ) = \frac{{\sum }_{j = j min}^{j = j max} [ p 1 ( {t}_{j} ) \times p 2 ( {t}_{j} ) ]}{{\{ {\sum }_{j = j min}^{j = j max} p 1 {( {t}_{j} )}^{2} \}}^{1 / 2} {\{ {\sum }_{j = j min}^{j = j max} p 2 {( {t}_{j} )}^{2} \}}^{1 / 2}} \qquad Eq . 1$$

in which the time axis is considered as divided into equal width segments, thus defining indexed time points, tⱼ, ranging from a practically defined lower time bound, t_{j min}, to a practically defined upper time bound, t_{j max}. Accordingly, the quantity PSC can theoretically have a range of 1 (perfect correlation) to −1 (perfect anti-correlation), but since negative going chromatographic peaks are not detected by PPD (by design) the lower limit is effectively zero. The time values or segment widths may be chosen so as to sample intensities a fixed number of times (for instance, between roughly seven and fifteen times, such as eleven times) across the width of an ion chromatogram peak. The masses to be correlated with the chosen ion then use the same time points. This means that if these masses form a peak at markedly different times, the intensities will be essentially zero. Partially overlapped peaks will have some zero terms. Operationally, the cross-correlation score, as shown in Step 93 of method 80 (FIG. 4) may range from 1.0 (perfect match) down to 0.0 (no match). Peak matches are recognized when a correlation exceeds a certain pre-defined threshold value. Experimentally, it is observed that limiting recognized matches to scores to those above 0.90 provides good filtering such that protein/peptide peaks are distinguished from peaks corresponding to non-peptide molecules.

In embodiments, the time window corresponding to each ROI is 0.6 minutes wide. This time windows represent a small portion of a typical chromatographic experiment which may run for several tens of minutes to on the order of an hour. In some implementations, data dependent instrument control functions may be performed in automated fashion, wherein the results obtained by the methods herein are used to automatically control operation of the instrument at a subsequent time during the same experiment from which the data were collected. For instance, based on the results of the algorithms, a voltage may be automatically adjusted in an ion source or a collision energy (that is applied to ions in order to cause fragmentation) may be adjusted with regard to collision cell operation. Such automatic instrument adjustments may be performed, for instance, so as to optimize the type or number of ions or ion fragments produced.

### Section 5. Examples

Biologically derived samples were subjected to fast-partial chromatographic separation (FPCS), which is described in international patent application (PCT) publication WO 2013/166169 A1. Generally, in performing FPCS, a complex mixture of various organic and inorganic analytes (small organic molecules, proteins and their naturally occurring fragments, lipids, nucleic acids, polysaccharides, lipoproteins, etc.) is loaded on a chromatographic column and subjected to a chromatographic separation. However, instead of allowing a mobile-phase gradient to elute each analyte separately (ideally, one analyte per chromatographic peak), the gradient is intentionally accelerated. In the FPCS technique, many analytes are intentionally co-eluted from the column at any given time according to their properties and the type of chromatography (reverse phase, HILIC, etc.) used. Partial or incomplete separation may be also accomplished by other methods known to one skilled in the art, including but not limited to the use of mobile phase solvents and/or modifiers that reduce retention of compounds on the column, selection of stationary phase media that reduce retention of compounds on the column (including particle size, pore size, etc.), operation of the chromatographic system at higher flow rate, operation of the chromatographic system at an elevated temperature, or selection of a different chromatographic separation mode (i.e., reversed-phase, size exclusion, etc.).

Since, in performing FPCS, there are substantially no well-resolved chromatographic peaks across the whole gradient, substantially all of the information about the analytes in a mixture is obtained from the mass spectra. Substantially the only relevant information derived from a chromatogram is the time of elution from the column. Each mass spectrum that is recorded represents a “subset” of co-eluting analytes that is then ionized, separated in mass analyzer and detected. The flow rates that are used in FPCS-MS, are standard for the type of a column in use. For example, flow rate may be 900 ul/min, 400 ul/min, 100 ul/min, 30 ul/min, 200 nl/min, and so on.

As one example of an FCPS separation, a reversed-phase chromatographic separation is performed on a 50 mm×2.1 mm internal diameter (ID) chromatographic column packed with 1.9 μm particles and pore size 175 Angstrom (C₁₈ stationary phase) using the following two mobile phases: 0.2% formic acid in water (mobile phase A) and 0.2% formic acid in acetonitrile (mobile phase B) at the flow rate 400 μL/minute. In this example, separation is performed in a 2%-80% gradient of mobile phase B in mobile phase A within either 2, 5 or 8 minutes.

As another example, a chromatographic column with 0.32 mm ID or smaller and packed with a C₄ stationary phase is used with a 20%-60% gradient of mobile phase B (acetonitrile with 0.2% formic acid) in mobile phase A (water with 0.2% formic acid) at a flow rate of approximately 10 μL/minute. The gradient elution time for the chromatographic separation may range from approximately 10 minutes to 25 20 minutes, followed by a short re-equilibration time that is typically less than the separation time.

As another example, the separation is performed on a 5 cm×2.1 mm ID column packed with Hypersil™ Gold C₁₈-like column material with 1.9μ particle size and a pore diameter of 170 Angstroms. Solvent A was composed of 100% H₂O and 0.2% formic acid and solvent B was made up of 100% acetonitrile and 0.2% formic acid. Starting conditions are 98% A and 2% B at a flow rate of 400 μL/minute and a column temperature of 40° C.

FIGS. 7-10 illustrate some typical examples of mass spectra obtained using the FPCS technique and filtered mass spectra generated by the methods in accordance with the present teachings. The topmost mass spectrum (i.e., FIGS. 7A, 8A, 9A and 10A) in each case is a raw, un-filtered mass spectrum. Each lowermost mass spectrum (i.e., FIGS. 7B, 8B, 9B and 10B) shown in the middle of each figure is a filtered spectrum illustrating just the ions that are highly correlated based on XIC peak shape. The lower diagram (i.e., FIGS. 7C, 8C, 9C and 10C) in each case is an extracted ion chromatogram and a fitted peak to the extracted ion chromatogram of a typical ion of the highly correlated set of ions. It is found in this work that filtering by lineshape will typically remove more than 90% of the ions in a particular scan from consideration as potential charge-state related ions (e.g., of peptides). The extracted ion chromatograms in FIGS. 7C, 8C, 9C and 10C are shown as solid line curves 202, 212, 222 and 232, respectively. The corresponding fitted peaks, comprising curves 204, 214, 224 and 234, respectively, are shown with dotted lines and shaded areas. The vertical scale in each of the above-noted figures is relative intensity (R.I.) which ranges from 0% to 100%, where the percentages are normalized relative to the most intense peak or point in the particular set of peaks or curves being plotted.

FIG. 7A is a mass spectrum of a peptide that co-elutes with one or more other compounds. It is difficult to discern which peaks are related to one another in this raw spectrum. FIG. 7B is a mass spectrum that is filtered according to the methods of the present teachings, showing only those peaks which XIC lineshapes are highly correlated (above a threshold). The evident progression of line positions in FIG. 7B is indicative of a charge envelope of the peptide. FIG. 7C shows a typical XIC corresponding to the highly correlated peaks. The pattern in FIG. 7B is relatively easy to discern, since the filtering procedure removes non-peptide peaks. The lineshape filtering methods taught herein can allow recognition of peaks that are part of a charge state envelope, even when this is not obvious from the raw mass spectrum. Using the information shown in FIG. 7B, it is possible to calculate the charge state corresponding to each line in the envelope and to thereby determine the mass of the peptide ion. A particular line corresponding to a certain charge state of the peptide ion may subsequently be selected, either automatically or manually, for isolation for further processing by fragmentation or ion-ion reaction.

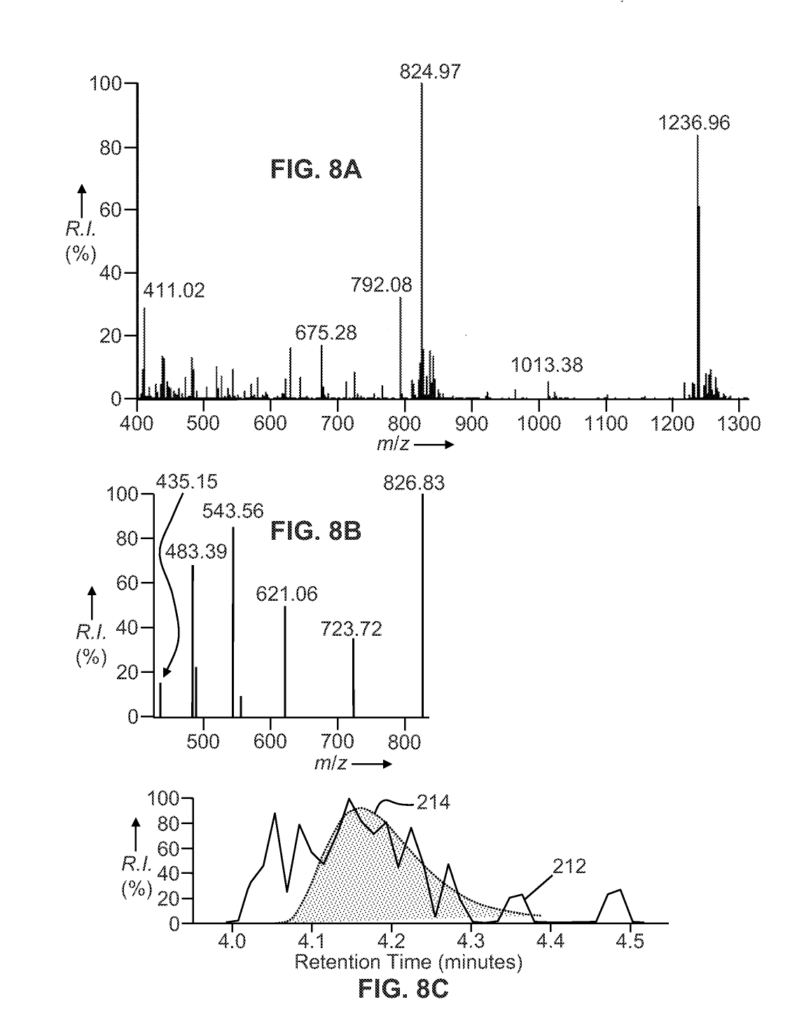

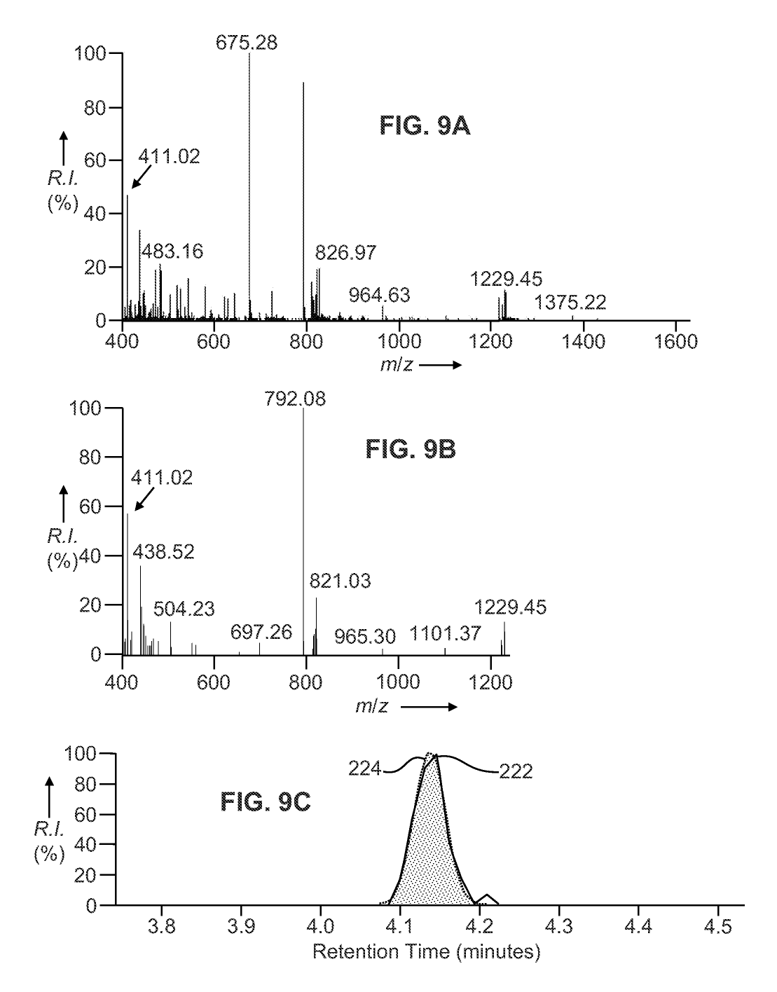

FIG. 8A provides another example of a mass spectrum of a peptide co-eluting with one or more other compounds. FIGS. 8B-8C show the filtered spectrum and a typical XIC corresponding to the highly correlated peaks. For comparison, FIG. 9 illustrates the raw spectrum, filtered spectrum and typical XIC pattern for a sample that does not exhibit a protein or peptide lineshape. Clearly, there is no charge state pattern evident in the filtered spectrum. Further, the XIC peak shown in FIG. 9C is clearly narrower and more symmetric than the XIC peaks (FIGS. 7C, 8C and 10C) associated with the peptides. Note that the horizontal axis is scaled similarly in all of FIGS. 7C, 8C, 9C and 10C, allowing for direct comparison.

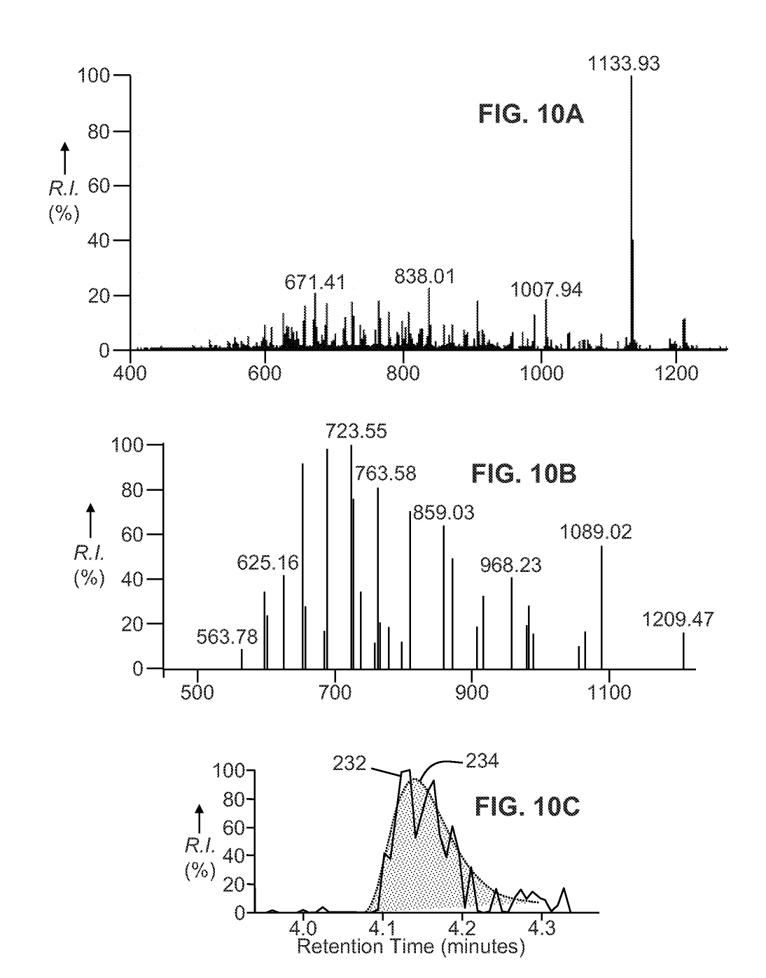

When multiple peptides co-elute and when the peptide peaks are of relatively low intensity, as in FIG. 10A, then the lineshape filter may not pass only ions in a single charge state envelope. For instance, multiple charge state envelopes are evident in the filtered spectrum shown in FIG. 10B. Nonetheless, even in this situation, XIC lineshape filtering still provide an order of magnitude of ion filtering, significantly simplifying the resulting filtered spectrum.

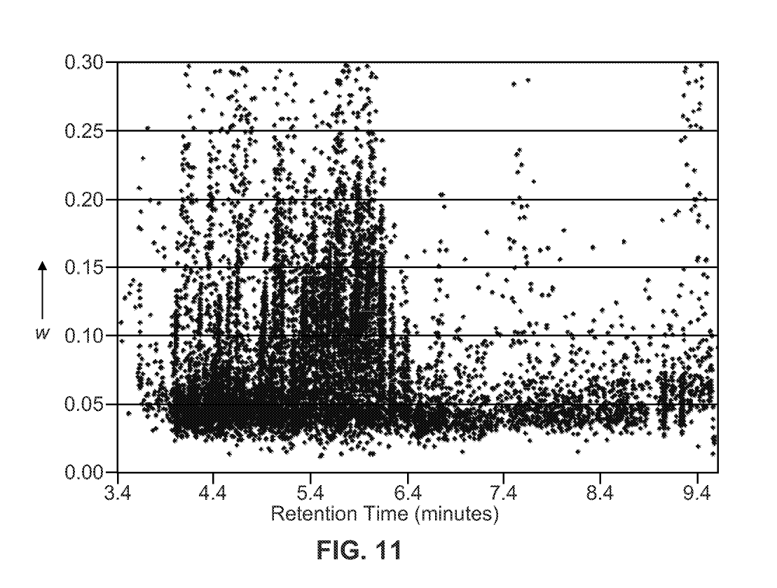

FIG. 11 is a scatter plot of peak widths versus retention times of various proteins and peptides and various other compounds. FIG. 11 shows the widths of 9200 XIC peaks found in a data file, plotted as peak width versus retention time. It is neither expected nor observed that the peak widths and shapes found in a typical LC/MS run will show resolved grouping of protein/peptide ions versus other ions. Rather, both the protein/peptide and other ions exhibit distributions of peak widths and shapes. Proteins and peptides show a range of peak widths, ranging from about 0.08 to 0.3 minutes, while other protonated molecules show a range centered on 0.04 minutes. However, there is a strong correlation between the peak asymmetry (compare FIG. 9C with FIGS. 7C, 8C and 10C) and the type of compound, with protein/peptide peaks showing an extended tail and non-peptide ions giving a symmetric XIC peak.

Different ways of employing this filtering technique are possible. For example, the practitioner could specify a range of shapes allowed. In another instance, the algorithm could compute the shape limits to use based on the data.

The discussion included in this application is intended to serve as a basic description. Although the invention has been described in accordance with the various embodiments shown and described, one of ordinary skill in the art will readily recognize that there could be variations to the embodiments and those variations would be within the spirit and scope of the present invention. The reader should be aware that the specific discussion may not explicitly describe all embodiments possible; many alternatives are implicit. For example, although the methods of the present teachings are especially advantageous when employed to analyze samples separated by fast partial chromatographic separations or other accelerated chromatography techniques, they may also be employed to analyze samples separated by conventional chromatography methods. Accordingly, many modifications may be made by one of ordinary skill in the art without departing from the spirit, scope and essence of the invention. Neither the description nor the terminology is intended to limit the scope of the invention. Any patents, patent applications, patent application publications or other literature mentioned herein are hereby incorporated by reference herein in their respective entirety as if fully set forth herein except that, insofar as such patents, patent applications, patent application publications or other literature may conflict with the present specification, then the present specification will control.

What is claimed is:

1. A method of analyzing a liquid mixture comprising protein or peptide analyte molecules that occur mixed with molecules of other compounds in a sample, said method comprising:
(a) passing a portion of the mixture through a liquid chromatograph such that a portion of the protein or peptide molecules and a portion of molecules of other compounds elute from the liquid chromatograph;
(b) transferring, to an ion source of a mass spectrometer, the eluted portion of the protein or peptide analyte molecules and the eluted portion of the molecules of other compounds so as to generate ions therefrom, the ions comprising a plurality of ion species;
(c) transferring the generated ion species to a mass analyzer of the mass spectrometer so as to detect the transferred ion species;
(d) generating a respective record of the intensity-versus-time variation of each of a plurality of the detected ion species;
(e) identifying a set of ion species corresponding to the ions generated from the eluted portion of the protein or peptide analyte molecules and distinguishing said identified ion species from a set of ion species corresponding to the ions generated from the eluted portion of the molecules of the other compounds based on the records of the intensity-versus-time variation; and
(f) performing at least one additional operation on ions of one or more of the distinguished ion species generated from the protein or peptide analyte molecules.

2. A method as recited in claim 1, wherein the at least one additional operation includes isolating one or more of the distinguished ion species generated from the protein or peptide molecules within the mass spectrometer.

3. A method as recited in claim 2, wherein the at least one additional operation includes:
fragmenting ions of the one or more isolated distinguished ion species so as to form fragment ion species; and
detecting the fragment ion species with the mass spectrometer.

4. A method as recited in claim 1, further comprising creating one or more entries in a database of molecule elution profile parameters and retention times based on the generated records of the intensity-versus-time variation.

5. A method as recited in claim 1, wherein the step (e) of identifying a set of ion species corresponding to the ions generated from the eluted portion of the protein or peptide analyte molecules includes identifying a set of ion species comprising a charge state envelope.

6. A method as recited in claim 5, further comprising identifying the charge states of one or more ion species comprising the charge state envelope.

7. A method as recited in claim 1, wherein the step (d) of generating a respective record of the intensity-versus-time variation of each of a plurality of the detected ion species comprises constructing a plurality of extracted ion chromatograms, each extracted ion chromatogram comprising a record of detected intensity of a respective detected ion species.

8. A method as recited in claim 7, wherein the constructing of each of the plurality of extracted ion chromatograms includes:
(d1) automatically fitting each record of intensity-versus-time variation with one or more calculated synthetic fit peaks;
(d2) eliminating synthetic fit peaks that do not satisfy an ion occurrence rule requiring the detected peaks to appear within a pre-determined number of consecutive mass spectral scans; and
(d3) eliminating synthetic fit peaks that do not satisfy a rule requiring the detected peaks to comprise a minimum intensity and a minimum area.

9. A method as recited in claim 8, wherein the step (e) of identifying a set of ion species corresponding to the ions generated from the eluted portion of the protein or peptide analyte molecules and distinguishing said identified ion species from a set of ion species corresponding to the ions generated from the eluted portion of the molecules of the other compounds comprises:
(e1) calculating cross-correlation scores for each pair of synthetic fit peaks; and
(e2) identifying the set of ion species corresponding to the ions generated from the eluted portion of the protein or peptide analyte molecules based on the calculated cross-correlation scores.

10. A method as recited in claim 8, further comprising creating one or more entries in a database of molecule elution profile parameters and retention times based on the calculated synthetic fit peaks.

11. A method as recited in claim 1, wherein the at least one additional operation on ions of one or more of the distinguished ion species generated from the protein or peptide analyte molecules comprises:
(f1) passing a second portion of the mixture through the liquid chromatograph such that a second portion of the protein or peptide molecules and a second portion of molecules of other compounds elute from the liquid chromatograph;
(f2) transferring, to the ion source of the mass spectrometer, the eluted second portion of the protein or peptide analyte molecules and the eluted second portion of the molecules of other compounds so as to re-generate the ion species;
(f3) transferring the re-generated ion species to the mass analyzer so as to detect the re-generated ion species;
(f4) isolating one or more of the distinguished ion species generated from the second portion of the protein or peptide molecules;
(f5) fragmenting the one or more isolated distinguished ion species to as to generate fragment ion species; and
(f6) analyzing the fragment ion species using the mass analyzer.

12. A method as recited in claim 11, further comprising providing a molecular identification of one or more of the protein or peptide molecules based on one or more mass-to-charge ratios of the analyzed fragment ion species.

13. A method as recited in claim 1 wherein the step (e) further includes identifying at least one of the protein or peptide analyte molecules.

14. A method as recited in claim 13 further comprising identifying a microorganism from which the sample was derived based on the at least one identified protein or peptide analyte molecule.

15. A method as recited in claim 3 further comprising identifying at least one of the protein or peptide analyte molecules based on the detecting of the fragment ion species.

16. A method as recited in claim 15 further comprising identifying a microorganism from which the sample was derived based on the at least one identified protein or peptide analyte molecule.

17. A method as recited in claim 1, wherein the step (a) comprises performing a fast partial chromatographic separation of the mixture.
